(19) United States
(12) Patent Application Publication
(10) Pub. No.: US 2016/0316711 A1
(43) Pub. Date: Nov. 3, 2016

(54) Pet Carrier Device

(71) Applicant: Carol Davis, Victorville, CA (US)

(72) Inventor: Carol Davis, Victorville, CA (US)

(21) Appl. No.: 15/139,086

(22) Filed: Apr. 26, 2016

Related U.S. Application Data
(60) Provisional application No. 62/154,570, filed on Apr. 29, 2015.

(51) Int. Cl. A01K 1/00; G05B 15/02; H01R 24/30; A01K 1/02

(52) U.S. Cl. CPC A01K 1/0052; A01K 1/0035; A01K 1/0245; A01K 1/029; A01K 1/0272; G05B 15/02; H01R 24/30; H01R 2103/00

(57) ABSTRACT

A pet carrier system for keeping an enclosed animal cool and comfortable in a hot location is provided. The pet carrier system comprises a pet container having an outer wall and an access opening formed in the outer wall. A coolant system is mounted in the outer wall of the pet container with the coolant system creating cooled air. Upon activation of the coolant system, the cooled air is directed into the pet container.

### CLAIM OF PRIORITY

This patent application claims priority under 35 USC 119 (e) (1) from U.S. Provisional Patent Application Ser. No. 62/154,570 filed Apr. 29, 2015, of common inventorship herewith entitled, “Pet Kool,” which is incorporated herein by reference as though the same were set forth in its entirety.

### FIELD OF THE INVENTION

The present invention pertains to the field of pet supplies, and more specifically to the field of pet carriers with heating or cooling capabilities.

### BACKGROUND OF THE INVENTION

Pets provide unconditional love, companionship and unmatched loyalty to their owners. Dogs and cats are more often considered a member of the family, as opposed to merely a pet, and most owners provide adequate shelter as well as a healthy diet for their animals. Many pet owners take their animals with them when traveling away from home. Whether heading off for a quick trip to the local pet store or embarking on a cross country family vacation, bringing along the family dog or cat affords the loving pet owner a simple means of spending quality time with their animal. When transporting a pet, an owner often utilizes a pet carrier to ensure their animal is safely restrained during transport. These carriers provide comfortable shelter for the animal and are an absolute necessity when taking the animal to the vet or embarking on excursions such as an afternoon outing or family vacation.

Sometimes a pet owner must leave the animal in their vehicle for an extended period to perform errands or other tasks associated with traveling with the pet. Whether stopping at a roadside diner for a quick meal during a family vacation or simply running into a grocery store to pick up a few needed items, leaving an animal in one's vehicle is a common occurrence for many pet owners. When leaving a dog or cat in a car during cool and cold days, an owner can place a blanket around the pet to keep the animal toasty warm. During balmy days of spring and summer, the temperature inside a car rises quickly to dangerous levels even with the windows cracked open. On a mild day that is approximately seventy three degrees outside, a vehicle heats up to approximately one hundred degrees in ten minutes and one hundred twenty degrees in thirty minutes. As the outdoor temperature rises, so does the heat buildup in a vehicle. At approximately ninety degrees outside, the interior of a vehicle heats up to approximately one hundred degrees within several minutes. A dog or cat left in a car for only a few minutes on a warm day can suffer serious injury or even death as a result of excessive temperatures inside the vehicle.

The prior art has put forth several designs for pet carriers with heating or cooling capabilities. Among these are:

U.S. Pat. No. 8,291,866 to Matt Cauchy and Cecil McKinney describes a heating and coolant system for portable pet living space and is able to efficiently heat and cool the pet because it heats and cools both the air surrounding the pet and the surfaces upon which the pet lays. The said invention comprises a portable pet carrier, one or more thermoelectric modules, a thermostatic control system, a power source, one or more conduction surfaces, one or more fans, one or more heat sinks, and an air plenum. The portable pet carrier is comprised of a ceiling, a floor, a plurality of walls, and one or more openings that allow the ingress and egress of pets to and from the portable pet carrier. The power source provides a current to one or more thermoelectric modules wherein one or more thermoelectric modules are configured to alternatively heat or cool the portable pet carrier. The thermostatic control system is configured to control an operation of one or more thermoelectric modules by commanding one or more thermoelectric modules to alternatively generate heating or cooling. The control system distributes current based on a calculated difference between a desired temperature and a measured temperature wherein the measured temperature is the temperature that a pet within the portable pet carrier experiences. The measured temperature is adjusted towards the desired temperature through conduction and convection. The one or more conduction surfaces are part of the floor of the portable pet carrier wherein one or more conduction surfaces allow heat conduction to and from a body of enclosed pet.

U.S. Pat. No. 6,490,995 to George Jefferson Greene, Jr. describes an apparatus for transporting animals in an air conditioned environment. The apparatus uses crushed ice to air condition an insulated animal container at approximately seventy four degrees Fahrenheit in ambient temperatures up to approximately one hundred twenty degrees Fahrenheit for approximately twelve hours on approximately one twenty pound charge of ice. The preferred embodiment is a self contained apparatus that contains storage components for an animal, ice, electric power, a ventilation fan, food and water. The device operates on approximately twelve volts DC and functions to transport animals in enclosed motor vehicles and common transport carriers such as airlines. Provided ice is present, an intrinsically safety backup system keeps the animal cool upon failure of the ventilation fan. An alternate embodiment is described for use by animal handlers who transport their animals in minivans.

U.S. Pat. No. 5,887,436 to Beverly J. Duddleston describes a cooled pet carrier comprising a housing for housing a pet and a coolant system therein. The coolant system comprises a Peltier module having a Peltier effect and a coolant system housing having a slidable lid member. The slidable lid member serves to recirculate cooled air from the interior of the housing to the Peltier module when the slidable lid member is in a first position. When the slidable lid member is in a second position, stale air vents from the interior of the housing and is replenished with fresh air.

None of these prior art references describe the present invention.

### SUMMARY OF THE INVENTION

It is an object of the present invention to provide a pet carrier with an integrated air coolant system that keeps an animal cool and comfortable when the animal is enclosed in the pet carrier in a hot location, such as inside a vehicle on a warm or hot day.

The present invention is a pet carrier system for keeping an enclosed animal cool and comfortable in a hot location. The pet carrier system comprises a pet container having an outer wall and an access opening formed in the outer wall. An air coolant system is mounted in the outer wall of the pet container with the air coolant system creating cooled air. Upon activation of the air coolant system, the cooled air is directed into the pet container.

In addition, the present invention further includes a method for keeping an enclosed animal cool and comfortable in a hot location. The method comprises providing a pet container having an outer wall and an access opening formed in the outer wall, mounting an air coolant system in the outer wall of the pet container, activating the air coolant system, creating cooled air, and directing the cooled air into the pet container.

The present invention further includes a pet carrier system for keeping an enclosed animal cool and comfortable in a hot location. The pet carrier system comprises a pet container having an outer wall and an access door formed in the outer wall. A closable door is selectively closable and releasably securable over the access opening. An air coolant system is mounted in the outer wall of the pet container with the air coolant system creating cool air. A fan directs the cool air to within an interior of the pet container. Operational controls activate the air coolant system and the fan. Upon activation of the air coolant system, cool air is directed into the pet container.

### BRIEF DESCRIPTION OF THE DRAWINGS

FIG. 1 is a perspective view illustrating a Pet Carrier System, constructed in accordance with the present invention, with a canvas covered pet container, an access opening having a door flap with a zipper closure, an air coolant system, and a car adapter for electrical power.

FIG. 2 is a front elevational view illustrating the air coolant system of the Pet Carrier System, constructed in accordance with the present invention, with the air coolant system having a least one fan for directing cooled air into the pet container.

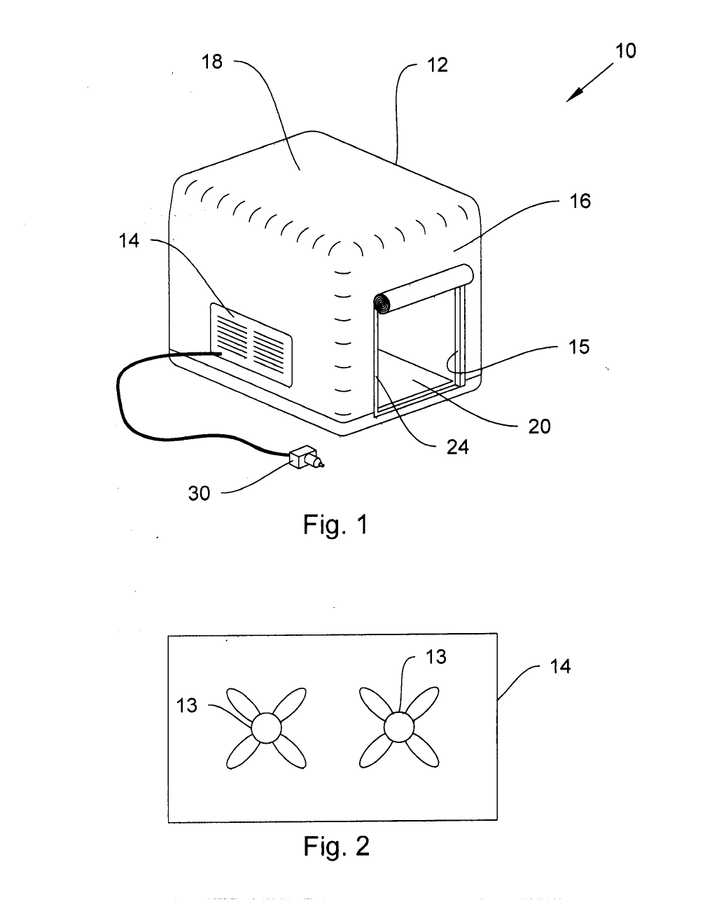

### DETAILED DESCRIPTION OF THE INVENTION

The present invention, hereinafter referred to as a Pet Carrier System 10, is a pet container 12 comprising an integrated air coolant system 14. The Pet Carrier 10 keeps an enclosed animal cool and comfortable if the animal is left in a vehicle on warm and hot days. The Pet Carrier System 10 is similar in general appearance to a traditional travel pet carrier but is far superior due to its ability to keep the pet cool and comfortable.

The pet container 12 of the Pet Carrier System 10 of the present invention is preferably constructed from a metal, plastic, nylon, or fiberglass framework 15 over which a breathable canvas material 16 is stretched. While the pet container 12 has been described and illustrated as being a framework 15 covered in a canvas material 16, it is within the scope of the present invention for the pet container 12 to be constructed from a rigid cover material with or without a framework 15 underneath the rigid cover material.

The pet container 12 of the Pet Carrier System 10 of the present invention preferably has a substantially rectangular cross sectional configuration with four side walls and a top wall. Preferably, the top wall is a domed roof 18 providing extra room for an animal housed within the pet container 12. An access opening 20 is formed in a front side wall of the pet container and provides ingress and egress for the animal. In a preferred embodiment, the access opening 20 as a closable door 22. Preferably, the closable door 22 is a flap closure that allows the access opening 20 to be selectively opened and closed. A sturdy zipper mechanism 24 releasably closes the flap closure over the opening of the access door allowing the user to secure the pet therein during use or as desired. It should be noted that while the pet container 12 has been described as having an access opening 20 closable with a zippered flap closure, it is within the scope of the present invention for the access opening 20 to be closed with a closable door 22 that is releasably secured by other means including, but not limited to, snaps, buttons, straps, etc.

In an embodiment of the present invention, the pet container 12 of the Pet Carrier System 10 of the present invention includes a carrying handle is secured to the top of the pet container 12 for use in easily transporting the pet container 12. Preferably, the handle is rotatable to a position against the pet container 12 allowing the handle to be stored in an out of the way position.

In addition, the Pet Carrier System 10 of the present invention includes the air coolant system 14 to deliver refreshing, cool air to the carrier, circulating this air freely about the animal and enabling them to remain cool and comfortable when left within the vehicle. Preferably, the air coolant system 14 is mounted to the side of the pet container 12 and includes an integrated fan 13 configured to direct cool air to within the interior of the pet container. Simple operational controls are positioned on the side of the pet container 12 or directly on the air coolant system 12 for use in activating the air coolant system 12 and/or the fan 13. Power is supplied to the air coolant system 12 and the fan 13 of the pet container by way of a rechargeable battery with a standard vehicle adapter cord 30 included to connect the air coolant system 12 and the fan 13 to the vehicle's cigarette lighter or power outlet.

When traveling with a dog or cat, the user places the animal in the pet container 12 of the Pet Carrier System 10 of the present invention prior to embarking on their excursion. The user then charges the battery of the Pet Carrier System 10 to optimum capacity by plugging the elongated adapter cord 30 into the vehicle's cigarette lighter or power outlet. If the user needs to leave their feline or pooch in the vehicle, they simply activate the integrated air coolant system 14 and/or the fan 13 prior to exiting their car. The Pet Carrier System's 10 air coolant system 14 blows cool air within the pet container 12, circulating the cool air around the animal and keeping them cool and comfortable for extended periods even when ambient temperatures within the vehicle rise to excessive levels. Upon returning to their vehicle, the user turns off the air coolant system 14 and the fan 13 and turns on the air conditioning of the vehicle to cool the entire vehicle and pet container 12 as the continue travelling. The owner easily removes the animal from the pet container 12 upon arrival at their destination.

It should be noted that while the air coolant system 14 and the fan 13 of the Pet Carrier System 10 of the present invention has been described and illustrated as operating together. It is within the scope of the present invention to operate the air coolant system 14 and the fan 13 separately and independently of each other. In this manner, if desired by the user, the air coolant 14 can be operated without operating the fan 13 and the fan 13 can be operated without operating the air coolant 14

The Pet Carrier System 10 of the present invention is constructed in a wide range of sizes to accommodate cats and dogs of different breeds including toy, small, medium and large animals. To accommodate all users, preferably the canvas covering 16 of the pet container 12 is constructed in a wide array of colors and printed designs and patterns. As a consideration, a software application for mobile computers, i.e., smartphones, tablets, and laptop computers, can be used in tracking the temperature of the Pet Carrier System 10 when away from one's vehicle, and warning pet owners should the temperature vary from its setting. A Pet Carrier System 10 sticker can be displayed in a vehicle window, so passersby will know the pet is safe.

A fully functioning travel carrier, the Pet Carrier System 10 of the present invention provides a secure and safe housing for the animal as they are transported from the home, to the vet's office, store, or on a family excursion. The Pet Carrier System 10 provides a cool environment for the animal on warm or hot summer days, thus protecting the animal from becoming uncomfortably hot, or worse, suffering heat stroke or even death as a result of rising temperatures in the vehicle. Durably constructed of quality materials, the Pet Carrier System 10 will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pet carrier system for keeping an enclosed animal cool and comfortable in an environment with elevated temperatures, the pet carrier system comprising:
a pet container having an outer wall and an access opening formed in the outer wall; and
a coolant system mounted in the outer wall of the pet container, the coolant system creating cool air;
wherein upon activation of the coolant system, cool air is directed into the pet container.

2. The pet carrier system of claim 1 wherein the pet container has a framework covered by a flexible material.

3. The pet carrier system of claim 1 wherein the framework is constructed from a material consisting of metal, plastic, nylon, and fiberglass and flexible material is a breathable canvas material.

4. The pet carrier system of claim 1 wherein the pet container has a domed roof.

5. The pet carrier system of claim 1 and further comprising:
a closable door selectively closable and releasably securable over the access opening.

6. The pet carrier system of claim 5 wherein the closable door includes a flap closure and a zipper mechanism associated with the flap closure for releasably securing the flap closure over the access opening.

7. The pet carrier system of claim 1 and further comprising:
a carrying handle secured to a top surface of the pet container;
wherein the handle is rotatable to a position against the pet container allowing the handle to be stored in an out of the way position.

8. The pet carrier system of claim 1 and further comprising:
a software application for mobile computers for tracking temperature within the pet container.

9. The pet carrier system of claim 1 and further comprising:
a fan associated with the coolant system for directing cool air to within an interior of the pet container.

10. The pet carrier system of claim 9 and further comprising:
operational controls positioned on a side of the carrier or directly on the coolant system for use in activating the coolant system and/or fan.

11. The pet carrier system of claim 1 wherein power is supplied to the coolant system by a rechargeable battery with a standard vehicle adapter cord for recharging the battery.

12. A method for keeping an enclosed animal cool and comfortable in an environment with elevated temperatures, the method comprising:
providing a pet container having an outer wall and an access opening formed in the outer wall;
mounting a coolant system in the outer wall of the pet container;
activating the coolant system;
creating cooled air; and
directing the cooled air into the pet container.

13. A pet carrier system for keeping an enclosed animal cool and comfortable in an environment with elevated temperatures, the pet carrier system comprising:
a pet container having an outer wall and an access door formed in the outer wall;
a closable door selectively closable and releasably securable over the access opening;
a coolant system mounted in the outer wall of the pet container, the coolant system creating cool air;
a fan for directing the cool air to within an interior of the pet container; and
operational controls for activating the coolant system and the fan;
wherein upon activation of the coolant system, cool air is directed into the pet container.

14. The pet carrier system of claim 13 wherein the pet container has a framework covered by a flexible material.

15. The pet carrier system of claim 13 wherein the framework is constructed from a material consisting of metal, plastic, nylon, and fiberglass and flexible material is a breathable canvas material.

16. The pet carrier system of claim 13 wherein the pet container has a domed roof.

17. The pet carrier system of claim 13 and further comprising:
a software application for mobile computers for tracking temperature within the pet container.

18. The pet carrier system of claim 17 wherein the closable door includes a flap closure and a zipper mechanism associated with the flap closure for releasably securing the flap closure over the access opening.

19. The pet carrier system of claim 13 and further comprising:
a carrying handle secured to a top surface of the pet container.
wherein the handle is rotatable to a position against the pet container allowing the handle to be stored in an out of the way position.

20. The pet carrier system of claim 13 wherein power is supplied to the coolant system by a rechargeable battery with a standard vehicle adapter cord for recharging the battery.
